(19) United States
(12) Patent Application Publication
(10) Pub. No.: US 2009/0199277 A1
(43) Pub. Date: Aug. 6, 2009

(54) CREDENTIAL ARRANGEMENT IN SINGLE-SIGN-ON ENVIRONMENT

(76) Inventors: James M. Norman, Pleasant Grove, UT (US); Cameron Mashayekhi, Salt Lake City, UT (US); Karl E. Ford, Highland, UT (US)

Correspondence Address: KING & SCHICKLI, PLLC, 247 NORTH BROADWAY, LEXINGTON, KY, 40507, US

(21) Appl. No.: 12/023,401

(22) Filed: Jan. 31, 2008

(51) Int. Cl. G06F 7/04

(52) U.S. Cl. 726/5

(57) ABSTRACT

Apparatus and methods arrange user credentials on physical or virtual computing devices utilizing a single-sign-on framework. During use, a plurality of target environments exist for a user to logon to one or more applications thereof, including at least a personal and workplace environment. One or more roles of the user are identified per each target environment, such as a shopper in the personal environment and an engineer or manager in the workplace environment. The user has credentials per each role and are used to logon using a single-sign-on session to access the one or more applications. The credentials are stored in a secret store corresponding to the defined roles of the user per either the personal or workplace environment. Workplace policies defining the roles or synching credentials are other features as are establishing default roles or retrofitting existing SSO services. Computer program products and computing interaction are also disclosed.

### FIELD OF THE INVENTION

Generally, the present invention relates to computing environments involving single-sign-on (SSO) experiences. Particularly, although not entirely, it relates to categorizing and grouping credentials and their utilization for SSO as a function of target environments in which user applications reside, including various identities assumed by users when authenticating to these environments. Workplace policies defining user roles or synching credentials are other features as are establishing default roles. Retrofitting existing SSO services and providing computer program products and computing interaction, to name a few, are still other features.

### BACKGROUND OF THE INVENTION

Newer computer operating systems such as Linux, Windows XP, or Windows Vista provide multiple credential stores for network client applications' usage. These credential stores usually are utilized to provide mechanisms for software applications to securely store credentials for the user, and retrieve them later for authentication to provide a single-sign-on (SSO) experience. They also do so in the context of minimizing user interaction.

As is known in the art, certain software applications have authentication engines “enabled” to detect the existence of an SSO software installation within the operating system of a computing device and its availability during an SSO session to store and/or retrieve credentials actively. An example of one such application would be Novell's Groupwise eMail software or Novell's Network Client. Another embodiment allows for “helper” software, provided by the SSO components installed on the operating system, to intercept authentication requests and dialogs by employing operating system available features to perform screen scraping (as it is commonly known) to capture credentials and store and retrieve user credentials for use. An example of such helper software is Novell's Secure Login. In still another embodiment, a system administrator or the user pre-populates a SSO credential store. In turn, a hybrid approach utilizes the “enabled” software embodiment to perform SSO through the use of “helper” software in the middle. An example of this type of SSO software would be Novell's CASA brand software (Common Authentication Services Adapter), Novell's Secure login, or Novell's SecretStore.

In any embodiment, however, there is no present mechanism to differentiate a single user having multiple identities or roles. For instance, a user might act as an engineer when authenticated to his workplace, corporate network and perform certain tasks as an engineer, and in another capacity might sign on and authenticate as a system administrator of an email system to perform certain administration tasks. In these two situations, there is a need for having the ability to synchronize and propagate to the corporate network in different capacities that are defined by what identity or role is assumed in signing on to the corporate network. Simiarly, a user might undertake a personal persona of a banking client who, via entry of personal credentials, checks daily balances in their on-line checking account. While perhaps using the same computing device, e.g., a client workstation, there is no need to intermingle credentials of one's personal persona with their workplace persona, nor is there need to synchronize personal credentials with a corporate network system. Among other things, such might cause confusion, unnecessarily expend computing resources or expose identities to theft.

In view of these various problems, there is need in the art of credentialing for SSO experiences to categorize and group credentials and their utilization for SSO sessions based on the target environment in which they are used. There is also a need to understand the needs, purposes and requirements of software offerings driving the differing nuances of SSO products when contemplating the categorizing and grouping of credentials. In that many computing configurations already have existing SSO technology, it is further desirable to leverage existing configurations by way of retrofit technology, thereby avoiding the costs of providing wholly new products. Talking advantage of existing frameworks, such as the CASA (Common Authentication Service Adapter) software offering by Novell, Inc., the common assignee of this invention, is another feature that optimizes existing resources. Any improvements along such lines should further contemplate keeping user interaction to a minimum, for otherwise, the SSO advantages are lost, and to maintain good engineering practices, such as automation, relative inexpensiveness, stability, ease of implementation, security, etc.

### SUMMARY OF THE INVENTION

The foregoing and other problems become solved by applying the principles and teachings associated with the hereinafter-described credential arrangement in an SSO environment. At a high level, methods and apparatus allow physical or virtual computing devices to employ multiple policy based key chains per a user's credential store in the SSO environment. During use, a plurality of target environments exist for a user to logon to one or more applications. The target environment, including representative personal and workplace environments, facilitates one or more roles of the user, such as a shopper in the personal environment and an engineer or manager in the workplace environment, to have single-sign-on access to the applications, but with different utilization. Per each role, the user has credentials that they use to logon and such are stored in a secret store corresponding to the defined roles of the user per either the personal or workplace environment. Workplace policies define the roles as well as the synching of credentials.

Default roles for forthcoming single-sign-on sessions contemplate using a last-used role or a predetermined role. In the former, the role the user last-used will be the default role upon a next login. In the latter, a predetermined default role can be set by a system administrator during configuration or the user via an administration utility of the workplace environment. Also, updating can occur during a SSO session in a secure manner. This is done by prompting the user for a master password to allow decrypting the key stored in the related profile to load that profile and switch roles. In any embodiment, security and differentiation require that only one role or profile be dominant and in use at a given time.

Ultimately, the mold of legacy SSO software is broken since users are able to categorize and group their credentials and their utilization for SSO based on the target environment that the applications reside in and the identities assumed when authenticating to these environments.

In one embodiment, the foregoing works in such a way that secrets that are associated with different roles can be grouped and encrypted with different keys associated and derived from the information in the profiles for those roles. These secrets are grouped together and partitioned in their corresponding secret or credential store. A management utility is upgraded to operate on secrets based on the default profile related to the role that is the default role. Details of key generation and encryption of the keys to be stored securely with a profile are adapted from knowledge in the existing arts.

In a computing system embodiment, the invention may be practiced with: secret stores; a client workstation; and a server arranged as part of pluralities of physical or virtual computing devices, including executable instructions for undertaking the foregoing credential arranging methodology. Computer program products are also disclosed and are available as a download or on a computer readable medium. The computer program products are also available for installation on a network appliance, such as a server, on a client workstation, or as retrofit technology with a SSO service such as Novell's CASA architecture.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for arranging credentials in an SSO environment;

FIGS. 2 and 3A-3B are high-level flow charts in accordance with the present invention for arranging credentials; and

FIG. 4 is a representative diagrammatic view in accordance with the present invention showing an arrangement of credentials in an SSO environment during use.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for arranging credentials in an SSO environment are hereinafter described.

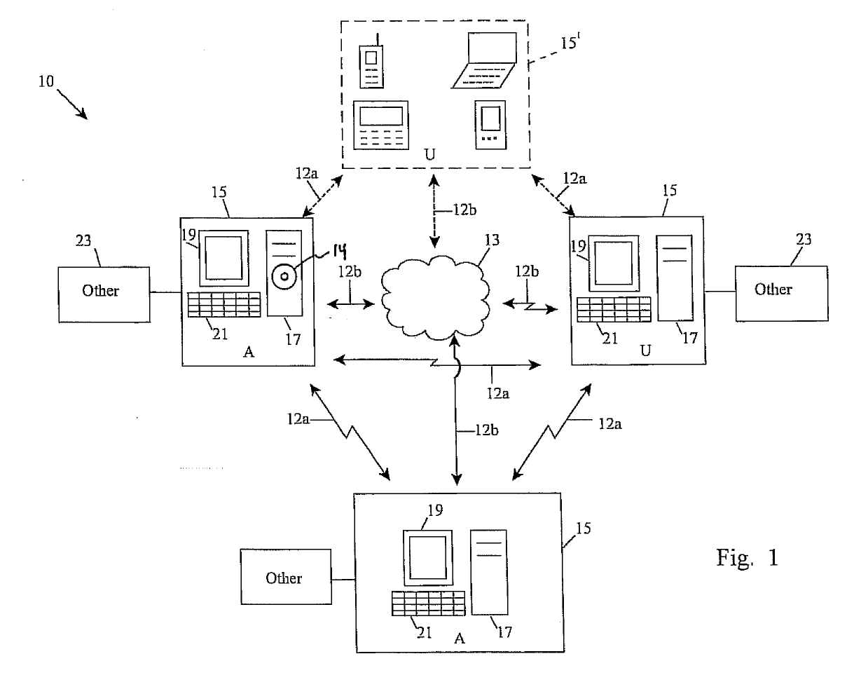

With reference to FIG. 1, a representative computing environment 10 for practicing certain or all aspects of the invention includes one or more computing devices 15 or 15′ arranged as individual or networked physical or virtual machines, including clients or hosts arranged with a variety of other networks and computing devices. In a traditional sense, an exemplary computing device typifies a server 17, such as a grid or blade server. Brand examples include, but are not limited to, a Windows brand Server, a SUSE Linux Enterprise Server, a Red Hat Advanced Server, a Solaris server or an AIX server. Alternatively, it includes a general or special purpose computing device in the form of a conventional fixed or mobile (e.g., laptop) computer 17 having an attendant monitor 19 and user interface 21. The computer internally includes a processing unit for a resident operating system, such as DOS, WINDOWS, MACINTOSH, LEOPARD, VISTA, UNIX, and LINUX, to name a few, a memory, and a bus that couples various internal and external units, e.g., other 23, to one another. Representative other items 23 include, but are not limited to, PDA's, cameras, scanners, printers, microphones, joy sticks, game pads, satellite dishes, hand-held devices, consumer electronics, minicomputers, computer clusters, main frame computers, a message queue, a peer computing device, a broadcast antenna, a web server, an AJAX client, a grid-computing node, a virtual machine, a web service endpoint, a cellular phone, or the like. The other items may also be stand alone computing devices 15′ in the environment 10 or the computing device itself.

In either, storage devices are contemplated and may be remote and/or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk 14 for insertion in a drive of computer 17. Computer executable instructions may also be available for installation as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be a download of executable instructions resident with a downstream computing device, or readable media, received from an upstream computing device or readable media, a download of executable instructions resident on an upstream computing device, or readable media, awaiting transfer to a downstream computing device or readable media, or any available media, such as RAM, ROM, EEPROM, CD-ROM, DVD, or other optical disk storage devices, magnetic disk storage devices, floppy disks, or any other physical medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T# lines, satellites, microwave relays or the like. The connections may also be local area networks (LAN), metro area networks (MAN), and/or wide area networks (WAN) that are presented by way of example and not limitation. The topology is also any of a variety, such as ring, star, bridged, cascaded, meshed, or other known or hereinafter invented arrangement.

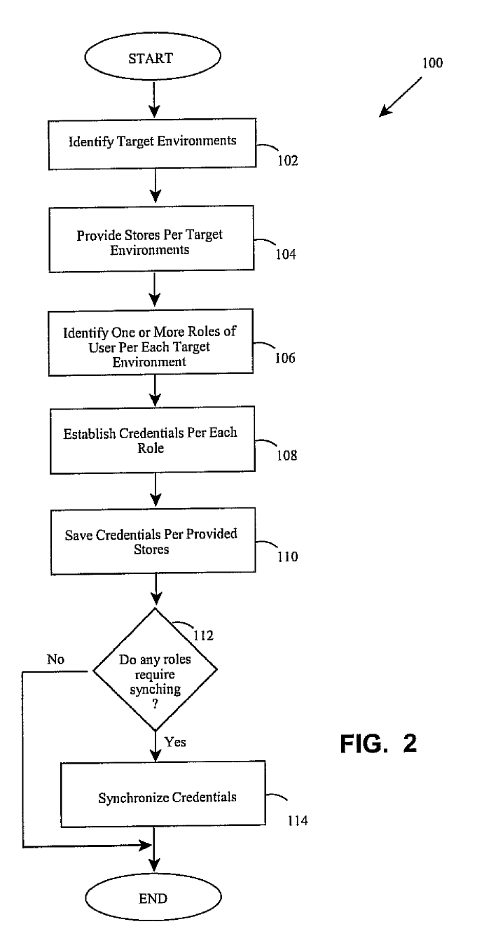

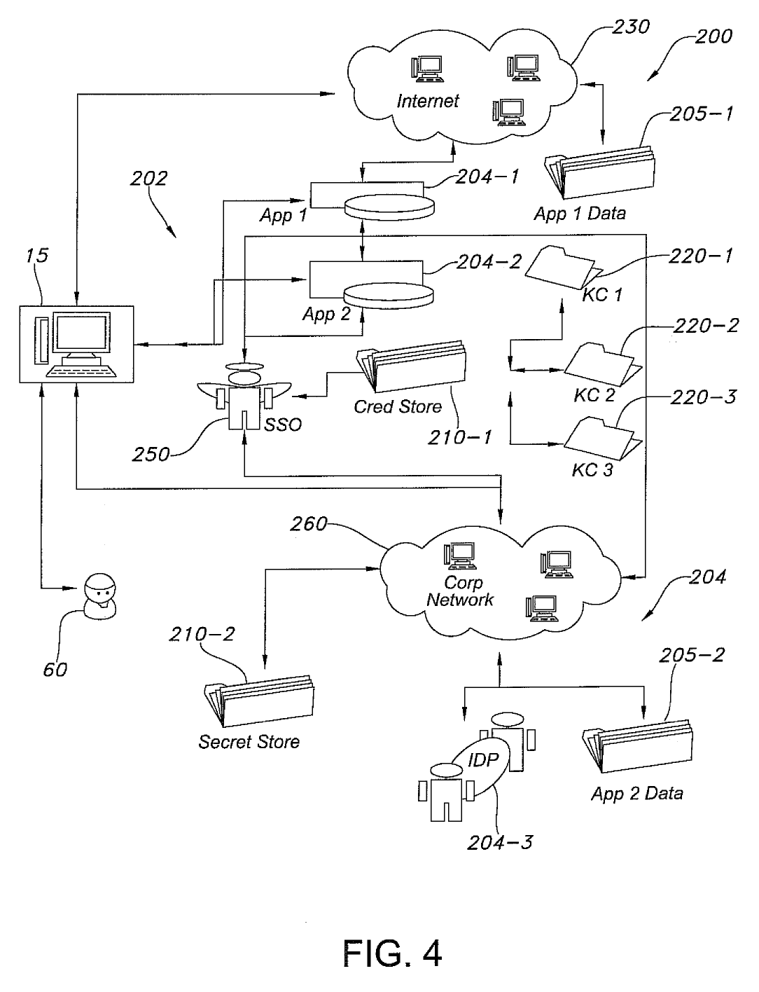

With the foregoing representative computing environment as backdrop, FIGS. 2 and 4 show an overall flow 100 and representative high-level architecture 200 of various aspects of the invention. That is, target environments for a user 60 are identified at step 102. Representatively, this means identifying those areas in which a user has need of a single-sign-on experience from his computing device 15. Among other things, this could mean identifying a personal environment 202 and a workplace environment 204, or identifying a hobby environment, a government environment, an organization environment, or the like. As will be seen, the user will then have SSO access to one or more applications 204-x of the target environment, including underlying application data 205-x, according to the various roles of the user. In turn, credential or secret stores 210 are provided for each of the target environments for storing credentials corresponding to the roles, step 104.

At step 106, the various roles of the user are identified per each of the target environments. For instance, in a personal environment 202, a user 60 may have roles corresponding to a shopper, banking client, husband, etc. In the workplace environment, the user might have roles corresponding to engineer, system administrator, manager, CEO, etc. Of course, other roles are possible and they relate to convenient ways to group the user in a specific environment. At step 108, each of the roles have credentials established that are utilized during an SSO session per a target environment and such are saved in the stores provided at step 110. (Novell's CASA provides an instance of a local credential store on a client.) Generally, this works in such a way that secrets that are associated with the different roles are grouped and encrypted with different keys associated and derived from the information in the profiles for those roles. They are grouped together and partitioned in the credential store and a management utility is upgraded to operate on secrets based on the default profile related to a default role (described below). Details of key generations and encryption of the keys to be stored securely with a profile are fairly well known in the art and not father discussed herein.

In one embodiment, the organization of secrets includes an arrangement of files in folders 220 in computing devices. In this regard, the folders are referred to as key chains where a user stores the credentials that unlock applications upon authentication. As a working example, consider the user 60 in a role of banking client to conduct on-line account management of a checking account at his bank's website and a separate 401(k) retirement account at his retirement service provider's website via the Internet 230. The user will have credentials, such as a username and pin, in order to access money and balances in banking accounts, which are stored generically as underlying data 205-1. In turn, the credentials are stored as key chain 220-1, in a store 210-1, that is reachable via a SSO software product 250 interfacing with an enabled application, such as 204-1. During use, the user singularly-signs-on in his role as banking client, via credentials at key chain 220-1 and accesses all his personal financial information.

Similarly, the user 60 in a role of shopper may have an eBay shopping account, an Amazon.com shopping account, etc., and such includes credentials such as a screen name and user id. In turn, storage of the credentials exist as a key chain 220-2, separate and divorced from key chain 220-1 for banking events, but within a single credential store 210-1. Appreciating the user needs to avoid commingling the two key chains, the credential store partitions the key chains as seen, but otherwise enables the user to have SSO sessions per either shopping events in the role of shopper or financial events in the role of banking client. Appreciating further a workplace environment has no interest in knowing or storing these credentials for the user, the key chains are wholly separate from the workplace target environment 204.

Thus, another embodiment contemplates categorizing and grouping credentials to satisfy confidentiality requirements. For example, the user might want to have their credentials that are related to their personal environment to be stored in a key chain different than the one that they store their corporate credentials needed to access their corporate or enterprise applications or underlying data 204-3, 205-2. As a side effect or byproduct of this need, a user might need to define profiles to regulate behavior of the key chain. For example, it would be desirable to avoid synchronizing, or propagating credentials that are stored in the personal environment with a back-end secret store 210-2 available on a corporate network, while at the same time it would be required or desirable to synchronize and propagate secrets in a corporate key chain with the secret store on a corporate or enterprise network. Thus, step 112 contemplates determining whether any roles of the user require synching. If so, synching occurs at step 114. Otherwise, processing ends.

As a working example, a user 60 might act in the role of engineer when authenticated to the corporate network 260 and perform certain tasks as an engineer using the applications of a server dedicated to research/development In another capacity or role, the user might sign on and authenticate as a system administrator of an email account to perform administration tasks on a separate, email server. At the same time, however, to minimize user interaction and to enjoy a SSO experience, these two roles illustrate the need to synchronize and propagate credentials in the form of a single username and id, for instance, to the corporate network corresponding to different capacities that are defined by what identity is assumed in signing on to the corporate network. However, it should be intuitively clear that in either situation, the user 60 is signing on to the client workstation with the identity that is defined on the workstation and then signing on to the corporate network with identities that would potentially be different than the one used on the workstation.

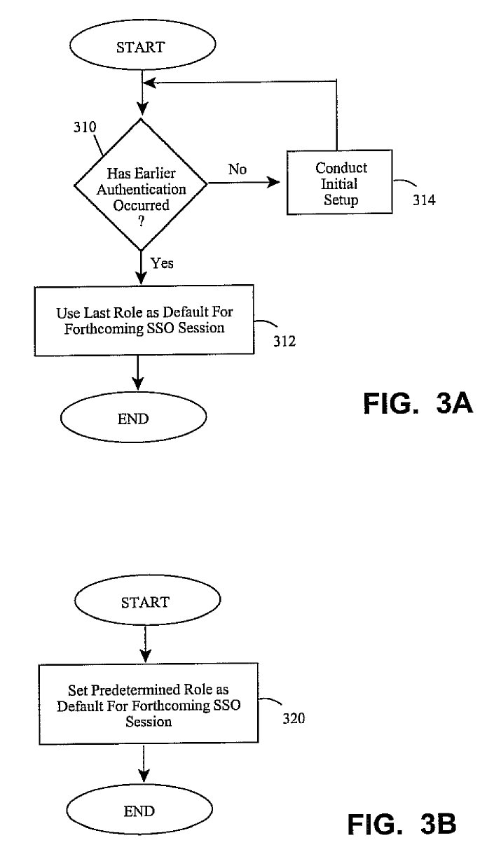

Now, skilled artisans will appreciate that for security and differentiation, only one role can be dominant and in use at any one time. Thus, there are certain instances of time when a default role might need to be supplied to the environment. With reference to FIGS. 3A and 3B, a default role is contemplated in a variety of ways. In a first, a determination is made regarding whether an earlier authentication of the user, per his credentials, has occurred, step 310. If so, the last-used role of the user is set as the default role for a forthcoming SSO session upon exit of the role of the user. In other words, the last-used role will be the same role of the user, unless changed, upon a next SSO login. On the other hand, if no earlier authentication has occurred, the user conducts an initial setup, step 314, such as described in FIG. 2. In a second, a predetermined role can be set by a system administrator or user via an administration utility of the SSO software, such as at step 320.

In the unlikely event of conflict, resolution can be accomplished by a policy indicated by the user as a preferred credential. In another, a particular store, or a particular key chain can be designated as a Master while another is designated a Servant. In still another, a user might be asked to resolve the conflict manually using an Administration or other tool. The resolution policy may also be indicated by a time frame, a security measure, combinations thereof, or any hereinafter contemplated feature useful in defining priorities.

In still other embodiments, roles can be changed during a SSO session in a administration utility of the SSO software in a secure manner. That is, the user is prompted for a master password to allow decrypting the key stored in a related profile to load that profile and switch roles.

In other embodiments, the workplace environment may dictate control over the SSO sessions, since its computing devices may be involved in both personal activities and workplace activities. Thus, the workplace environment may set a policy indicating acceptable roles of the one or more roles of the user. For example, the workplace may not want to take responsibility for nefarious or illegal activities that a user desires to engage in and so prevents creation of certain roles of the user. Alternatively, the workplace environment may set a policy indicating what events trigger synchronization of credentials. Still other policies are possible and skilled artisans will easily recognize them.

Various specific SSO frameworks for use with the invention include, but are not limited to, SecretStore, Firefox Password Manager, Gnome Keyring, KDE Wallet, CASA and miCASA. In more detail of one embodiment, Novell's CASA is a common authentication and security package that provides a set of libraries for application and service developers to enable single sign-on for an enterprise network. Version 1.7, for example, provides a local, session-based credential store (called miCASA) that is populated with desktop and network login credentials. A CASA manager serves as a user interface module, whereby users interface with their credentials in the various stores.

Appreciating users will likely have many different credentials amongst the various credential stores, convenient locating and replacing of these is another aspect of the invention. With regard to pending U.S. patent application Ser. No. 11/901,397, entitled, SETTING AND SYNCHING PREFERRED CREDENTIALS IN A DISPARATE CREDENTIAL STORE ENVIRONMENT, filed Sep. 17, 2007, reference is taken and its teaching is incorporated herein in its entirety.

In any embodiment, certain advantages and benefits over the prior art should be readily apparent. For example, but not limited to, the invention provides advantage by breaking the mold of legacy SSO software since users are now able to categorize and group their credentials, and their utilization for SSO sessions, based on the target environment and its applications in which the user will be operating when authenticating to these environments. In all embodiments, the invention allows maintaining seamless and uninterrupted SSO service for users.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment utilizing a single-sign-on framework on one or more physical or virtual computing devices, a method of arranging user credentials, comprising:
identifying a plurality of target environments for a user to logon to one or more applications thereof;
providing a secret store per each said target environment;
identifying one or more roles of the user per each said target environment that the user can logon using a single-sign-on and access the one or more applications;
establishing credentials for each of the one or more roles to use the single-sign-on; and
saving the credentials in a corresponding one of the secret stores according to each said target environment.

2. The method of claim 1, further including determining whether any of the one or more roles of the user per each said target environment require credential synchronization.

3. The method of claim 1, wherein the identifying the plurality of target environments includes identifying a personal and workplace environment of the user.

4. The method of claim 3, wherein the workplace environment further establishes a policy for acceptable roles of the one or more roles of the user per each said target environment.

5. The method of claim 1, wherein the saving further includes creating one or more key chains.

6. The method of claim 1, further including establishing a default role of the one or more roles of the user for a forthcoming single-sign-on session.

7. The method of clam 6, wherein the establishing the default role further includes using a last-used role or a predetermined role.

8. The method of claim 1, further including retrofitting an existing single-sign-on service.

9. In a computing system environment utilizing a single-sign-on framework on one or more physical or virtual computing devices, a method of arranging user credentials, comprising:
identifying a plurality of target environments for a user to logon to one or more applications thereof;
providing a secret store per each said target environment;
identifying one or more roles of the user per each said target environment that the user can logon using a single-sign-on and access the one or more applications;
establishing credentials for each of the one or more roles to use the single-sign-on;
saving the credentials in a corresponding one of the secret stores according to each said target environment including creating one or more key chains; and
establishing a default role of the one or more roles of the user for a forthcoming single-sign-on session.

10. In a computing system environment utilizing a single-sign-on framework on one or more physical or virtual computing devices, a method of arranging user credentials, comprising:
identifying a plurality of target environments for a user to logon to one or more applications thereof, the target environments including at least a personal and workplace environment;
providing a separate local or remote secret store per each said target environment;
identifying one or more roles of the user per each said target environment that the user can logon using a single-sign-on and access the one or more applications, the workplace environment establishing a policy for acceptable roles of the one or more roles of the user;
establishing credentials for each of the one or more roles to use the single-sign-on;
saving the credentials in a corresponding one of the secret stores according to each said target environment; and
establishing a default role of the one or more roles of the user for a forthcoming single-sign-on session.

11. The method of claim 10, wherein the establishing the default role further includes using a last-used role or a predetermined role.

12. The method of claim 10, wherein the establishing the default role further includes determining whether an earlier user authentication has occurred.

13. The method of claim 11, wherein the using the predetermined role further includes setting the predetermined role by a system administrator of the workplace environment.

14. The method of claim 11, wherein the using the predetermined role further includes setting the predetermined role by the user via an administration utility of the workplace environment.

15. A computer program product available as a download or on a computer readable medium having executable instructions for installation on one or more physical or virtual computing devices utilizing a single-sign-on framework, comprising:
a first component for receiving identification of a plurality of target environments for a user to logon to one or more applications thereof, the target environments including at least a personal and workplace environment;
a second component for receiving identification of one or more roles of the user per each said target environment that the user can logon using a single-sign-on and access the one or more applications;
a third component for receiving indication of credentials for each of the one or more roles to use the single-sign-on; and
a fourth component to communicate with a secret store per each said target environment to save the credentials in a corresponding one of the secret stores.

16. The computer program product of claim 15, further including a fifth component for receiving identification of a default role of the one or more roles of the user for a forthcoming single-sign-on session.

17. The computer program product of claim 15, further including a fifth component for receiving a policy of the workplace environment indicating acceptable roles of the one or more roles of the user.

18. The computer program product of claim 15, further including a fifth component for receiving a policy of the workplace environment indicating synchronizing events per the credentials.

19. The computer program product of claim 15, wherein one or more of the components resides with a server of the workplace environment.

20. A computing system for arranging user credentials on one or more physical or virtual computing devices utilizing a single-sign-on framework, comprising:
a client workstation arranged as one of the one or more physical or virtual computing devices, a user of the client workstation able to logon using a single-sign-on thereby having access to one or more applications of a plurality of target environments including at least a single-sign-on session for a personal environment and a separate single-sign-on session for a workplace environment;
a server arranged as another of the one or more physical or virtual computing devices, the server existing in the workplace environment and configured to communicate with the client workstation, the server having a policy defining roles of the user in both the personal and workplace environment; and
a secret store per each said target environment for storing credentials corresponding to the defined roles of the user per either the personal or workplace environment.
